(19) United States
(12) Patent Application Publication
(10) Pub. No.: US 2013/0085694 A1
(43) Pub. Date: Apr. 4, 2013

(54) ENERGY USAGE AMOUNT MANAGING APPARATUS, ENERGY USAGE AMOUNT MANAGEMENT METHOD, AND COMPUTER READABLE MEDIUM

(71) Applicant: Haruki MATSUI, Kanagawa (JP)

(72) Inventor: Haruki MATSUI, Kanagawa (JP)

(73) Assignee: FUJI XEROX CO., LTD., Tokyo (JP)

(21) Appl. No.: 13/472,586

(22) Filed: May 16, 2012

(30) Foreign Application Priority Data
Oct. 3, 2011 (JP) 2011-219391

(51) Int. Cl. G06F 19/00

(52) U.S. Cl. 702/62

(57) ABSTRACT

An energy usage amount managing apparatus includes a memory, an estimating unit, a specifying unit, an information output unit, an input receiving unit, and an updating unit. The memory stores appliance information about an energy usage status in each of appliances installed in a space having plural areas, and stores information about the areas and information about users. The estimating unit estimates an energy usage amount in each of the areas by using the appliance information. The specifying unit specifies a user corresponding to an area where a difference between an energy usage amount measured by a measuring apparatus and an energy usage amount estimated by the estimating unit satisfies a predetermined condition. The information output unit outputs information for prompting the specified user to input the appliance information. The input receiving unit receives input of the appliance information. The updating unit updates the content stored in the memory.

### CROSS-REFERENCE TO RELATED APPLICATIONS

This application is based on and claims priority under 35 USC 119 from Japanese Patent Application No. 2011-219391 filed Oct. 3, 2011.

### BACKGROUND

(i) Technical Field

The present invention relates to an energy usage amount managing apparatus, an energy usage amount management method, and a computer readable medium.

(ii) Related Art

Recently, the need for saving energy has been socially growing. Under this trend, various systems for indicating and estimating a usage amount of energy, such as electricity or gas, have been developed.

### SUMMARY

According to an aspect of the invention, there is provided an energy usage amount managing apparatus including a memory, an estimating unit, a specifying unit, an information output unit, an input receiving unit, and an updating unit. The memory stores appliance information about an energy usage status in each of appliances installed in a space having plural areas, and stores information about the plural areas and information about users in association with each other. The estimating unit estimates, in accordance with a predetermined algorithm, an energy usage amount in each of the plural areas by using the appliance information stored in the memory. The specifying unit specifies, with reference to content stored in the memory, a user corresponding to an area where a difference between an energy usage amount measured by a measuring apparatus and an energy usage amount estimated by the estimating unit satisfies a predetermined condition among the plural areas. The measuring apparatus is provided in each of the plural areas and measures an energy usage amount in a corresponding one of the plural areas. The information output unit outputs information for prompting the user specified by the specifying unit to input the appliance information about an appliance installed in the area where the difference between the measured energy usage amount and the estimated energy usage amount satisfies the predetermined condition among the appliances. The input receiving unit receives input of the appliance information. The updating unit updates the content stored in the memory by using the appliance information received by the input receiving unit.

### BRIEF DESCRIPTION OF THE DRAWINGS

Exemplary embodiments of the present invention will be described in detail based on the following figures, wherein:

FIG. 1 is a diagram illustrating an overview of an energy usage amount managing system;

FIG. 2 is a block diagram illustrating an example of a configuration of the energy usage amount managing system;

FIG. 3 is a block diagram illustrating an example of a hardware configuration of a managing apparatus;

FIG. 4 is a diagram illustrating an example of content stored in a measurement point definition storage region;

FIG. 5 is a diagram illustrating an example of content stored in an employee information storage region;

FIG. 6 is a diagram illustrating an example of content stored in a measurement value storage region;

FIG. 7 is a diagram illustrating an example of content stored in an appliance information storage region;

FIG. 8 is a diagram illustrating an example of content stored in an update history storage region;

FIG. 9 is a block diagram illustrating an example of a functional configuration of the managing apparatus;

FIG. 10 is a flowchart illustrating a flow of a process performed by a controller of the managing apparatus;

FIG. 11A is a diagram illustrating measurement results in the individual areas;

FIG. 11B is a diagram illustrating a simulation result of power usage amounts in a system according to the related art;

FIG. 11C is a diagram illustrating a simulation result of power usage amounts in an exemplary embodiment of the present invention; and

FIG. 12 is a diagram illustrating an example of a screen presenting an update history.

### DETAILED DESCRIPTION

### A: Configuration

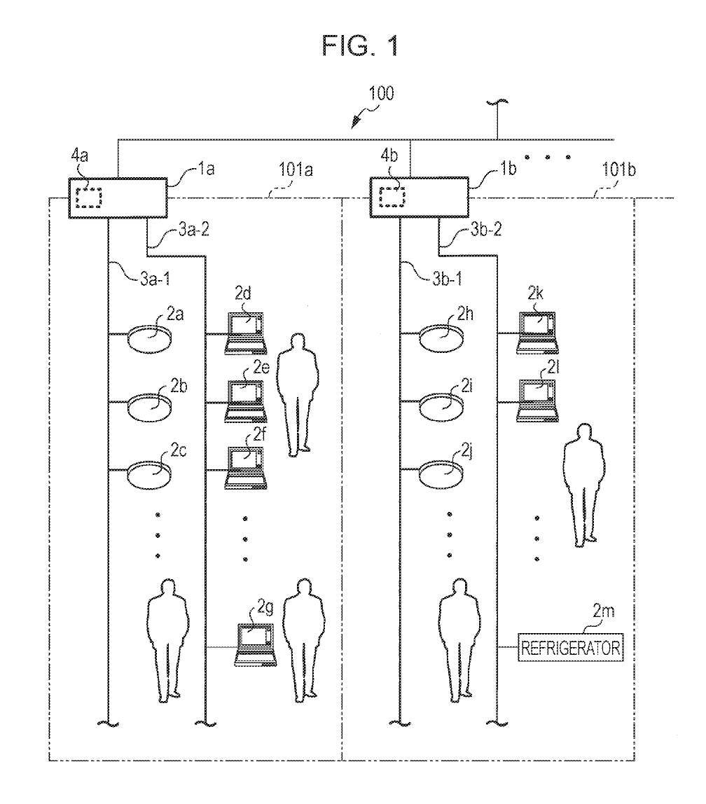

FIG. 1 is a diagram illustrating an overview of an energy usage amount managing system according to an exemplary embodiment of the present invention. In FIG. 1, a space 100 is a space in a building or house, for example. Plural distribution switchboards 1a, 1b, etc., and plural appliances 2a, 2b, etc. are provided in the space 100. The distribution switchboards 1a, 1b, etc. each include an earth leakage circuit breaker and a molded case circuit breaker, and supply power supplied from the outside to lines 3a-1 and 3a-2, 3b-1 and 3b-2, etc. installed in the space 100. The appliances 2a, 2b, etc. are appliances that consume power, such as a personal computer, a fluorescent lamp, and a refrigerator, and perform various operations by using power supplied through any one of the lines 3a-1, 3a-2, 3b-1, 3b-2, etc. In the description given below, each of the appliances 2a, 2b, etc. will be referred to as an “appliance 2” when it is not necessary to distinguish them from one another, for the convenience of description. This is the same for the distribution switchboards 1a, 1b, etc. When it is not necessary to distinguish them from one another, each of them will be referred to as a “distribution switchboard 1”.

The space 100 includes areas 101a, 101b, etc. in which the appliances 2 supplied with power from the respective distribution switchboards 1a, 1b, etc. are installed. Specifically, the appliances 2 supplied with power from the distribution switchboard 1a are installed in the area 101a, and the appliances 2 supplied with power from the distribution switchboard 1b are installed in the area 101b. The areas 101a, 101b, etc. may be, for example, rooms defined by walls or work areas defined by partitions. In the example illustrated in FIG. 1, the appliances 2a, 2b, . . . , and 2g are installed in the area 101a, and the appliances 2h, 2i, . . . , and 2m are installed in the area 101b. In the description given below, each of the areas 101a, 101b, etc. will be referred to as an “area 101” when it is not necessary to distinguish them from one another, for the convenience of description.

The distribution switchboards 1a, 1b, etc. are provided with measuring apparatuses 4a, 4b, etc. for integrating and measuring power in the respective distribution switchboards 1a, 1b, etc. Each of the measuring apparatuses 4a, 4b, etc. is a so-called watthour meter, and corresponds to an example of a measuring apparatus according to an exemplary embodiment of the present invention. In the description given below, each of the measuring apparatuses 4a, 4b, etc. will be referred to as a “measuring apparatus 4” when it is not necessary to distinguish them from one another, for the convenience of description.

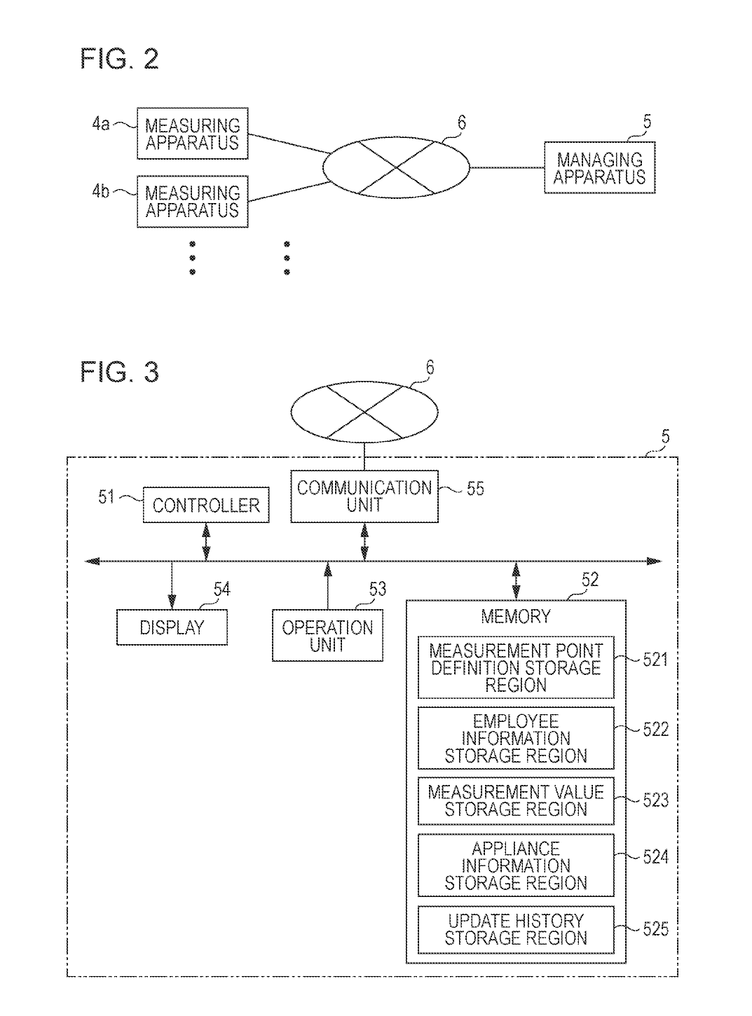

FIG. 2 is a block diagram illustrating an example of a configuration of the system according to this exemplary embodiment. In FIG. 2, the measuring apparatuses 4a, 4b, etc. are connected to a managing apparatus 5 via a communication network 6, such as a local area network (LAN). The managing apparatus 5 simulates a power usage amount in the space 100, and corresponds to an example of an energy usage amount managing apparatus according to an exemplary embodiment of the present invention.

FIG. 3 is a block diagram illustrating an example of a hardware configuration of the managing apparatus 5. In FIG. 3, a controller 51 includes a central processing unit (CPU), a read only memory (ROM), and a random access memory (RAM), and controls the managing apparatus 5 in accordance with a program stored in the ROM or a memory 52. The memory 52 is a hard disk or the like, and stores various programs including a program related to control of the managing apparatus 5. The memory 52 corresponds to an example of a memory according to an exemplary embodiment of the present invention. An operation unit 53 includes a keyboard, a mouse, and the like. A user of the managing apparatus 5 performs various operations by using the operation unit 53. A display 54 includes a display panel, such as a liquid crystal display, and displays various images under control performed by the controller 51. A communication unit 55 communicates with an external apparatus. Here, an external apparatus is, for example, another memory or an apparatus connected via a communication network. The communication unit 55 may communicate with an external apparatus in a wired manner, or may communicate with an external apparatus wirelessly through infrared communication or the like.

In the example illustrated in FIG. 3, the operation unit 53 and the display 54 are provided in the managing apparatus 5. Alternatively, the operation unit 53 and the display 54 may be externally attached to the managing apparatus 5. In this case, an external input terminal and an external output terminal may be provided to the managing apparatus 5, and the operation unit 53 and the display 54 may be connected to the external input terminal and the external output terminal.

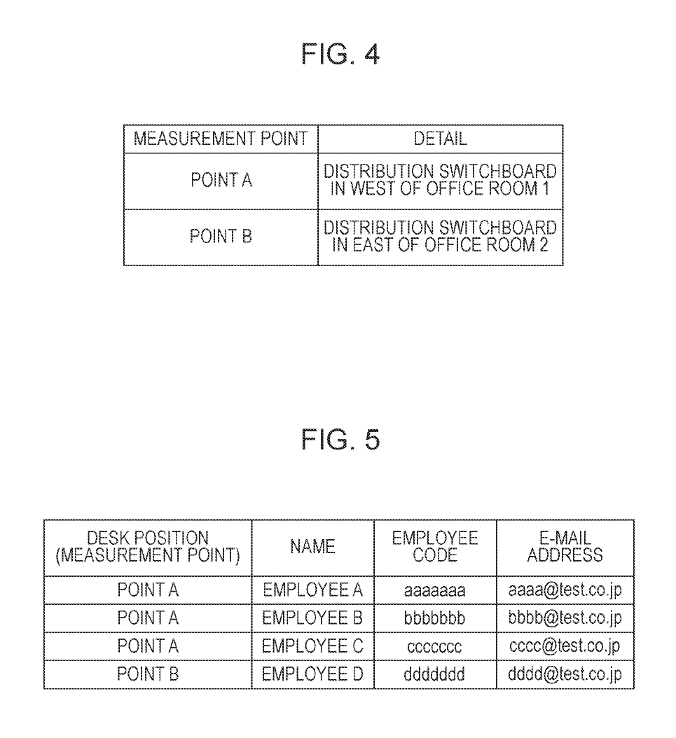

The memory 52 includes, as illustrated in FIG. 3, a measurement point definition storage region 521, an employee information storage region 522, a measurement value storage region 523, an appliance information storage region 524, and an update history storage region 525. The measurement point definition storage region 521 stores information about measurement points (the measuring apparatuses 4 in this exemplary embodiment) at which a power usage amount is definite. FIG. 4 is a diagram illustrating an example of content stored in the measurement point definition storage region 521. As illustrated in FIG. 4, the items “measurement point” and “detail” are stored in this region in association with each other. In the item “measurement point”, information indicating the positions of the measuring apparatuses 4 (i.e., identification information identifying the areas 101), such as “point A” and “point B”, is stored. In the item “detail”, information indicating the positions where the measuring apparatuses 4 are installed, such as “distribution switchboard in west of office room 1” and “distribution switchboard in east of office room 2”, is stored.

The employee information storage region 522 stores information about users who uses the individual areas 101, such as employees having their desks in the individual areas 101. FIG. 5 is a diagram illustrating an example of content stored in the employee information storage region 522. As illustrated in FIG. 5, the items “desk position”, “name”, “employee code”, and “e-mail address” are stored in this region in association with one another. In the item “desk position”, identification information identifying the areas 101 is stored. In the item “name”, character strings representing the names of users are stored. In the item “employee code”, employee codes assigned to the users are stored. In the item “e-mail address”, character strings representing e-mail addresses of the users are stored.

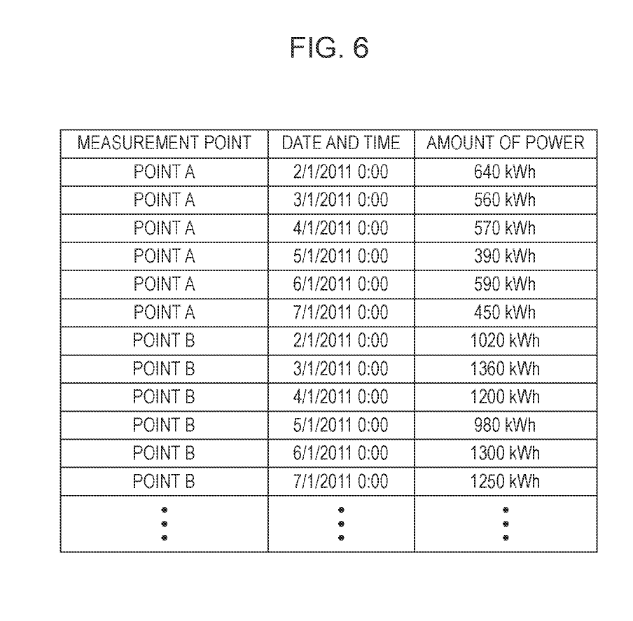

The measurement value storage region 523 stores results of measurements of power performed by the measuring apparatuses 4. FIG. 6 is a diagram illustrating an example of content stored in the measurement value storage region 523. As illustrated in FIG. 6, the items “measurement point”, “date and time”, and “amount of power” are stored in this region in association with one another. In the item “measurement point”, identification information identifying the areas 101 is stored. In the item “date and time”, information indicating the date and time when measurement was performed is stored. In the item “amount of power”, information indicating the amount of power that is measured is stored. In the example illustrated in FIG. 6, the amount of power is measured monthly by the measuring apparatuses 4, and information indicating the measurement results is sequentially stored in this table.

The measurement results are not limited to those obtained through measurement using measuring apparatuses. For example, the values of power usage amounts shown in meter read reports provided from a power company every month may be used as the measurement results, which may be input manually.

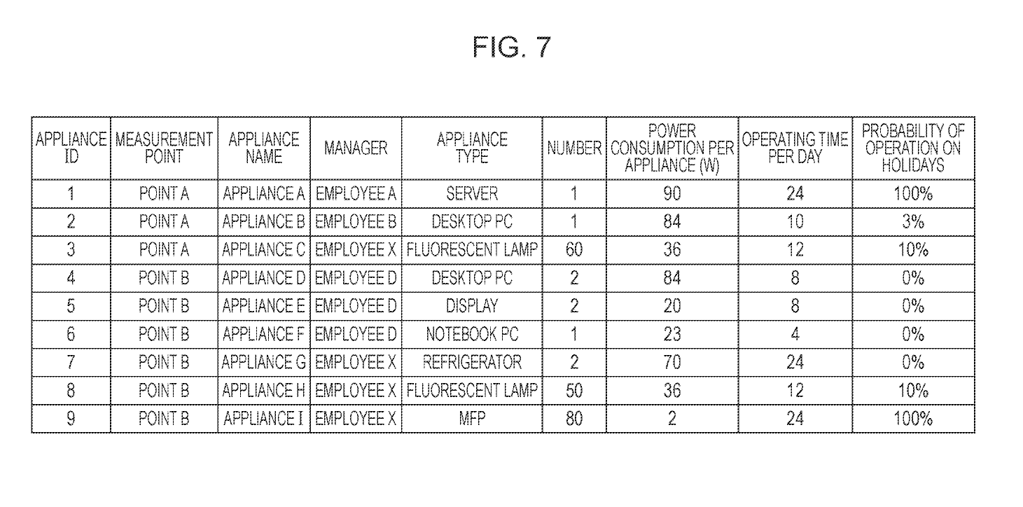

The appliance information storage region 524 stores data for simulating power usage amounts of individual appliances. FIG. 7 is a diagram illustrating an example of content stored in the appliance information storage region 524. As illustrated in FIG. 7, the items “appliance ID”, “measurement point”, “appliance name”, “manager”, “appliance type”, “number”, “power consumption per appliance (W)”, “operating time per day”, and “probability of operation on holidays” are stored in this region in association with one another. In the item “appliance ID”, identification information identifying the appliances 2 is stored. In the item “measurement point”, identification information identifying the areas 101 is stored. In the item “appliance name”, character strings representing the names of the appliances 2 are stored. In the item “manager”, information indicating the users who manage the individual appliances 2 is stored. In the item “appliance type”, information indicating the types of the appliances 2 is stored. In the item “number”, information indicating the numbers of the appliances 2 is stored. In the item “power consumption per appliance (W)”, information indicating the power consumption per appliance 2 is stored. In the item “operating time per day”, information indicating the operating time per day of each appliance 2 is stored. In the item “probability of operation on holidays”, information indicating the probability of each appliance 2 operating on holidays is stored.

The information stored in the items “number”, “power consumption per appliance (W)”, “operating time per day”, and “probability of operation on holidays” among the items illustrated in FIG. 7 corresponds to an example of appliance information according to an exemplary embodiment of the present invention. The appliance information is information about a power usage status in the appliances 2, and is used by the controller 51 of the managing apparatus 5 to perform a process of simulating a power usage amount, which will be described below. As illustrated in FIG. 7, the appliance information storage region 524 stores appliance information about a power usage status in each appliance 2 installed in the space 100, and also stores information about the areas 101 and information about users in association with each other.

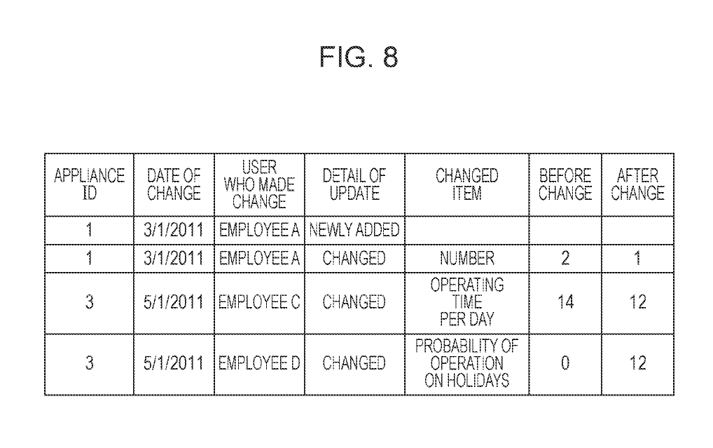

The update history storage region 525 stores a history of changes in appliance information. FIG. 8 is a diagram illustrating an example of content stored in the update history storage region 525. As illustrated in FIG. 8, the items “appliance ID”, “date of change”, “user who made change”, “detail of update”, “changed item”, “before change”, and “after change” are stored in this region in association with one another. In the item “appliance ID”, identification information identifying the appliances 2 is stored. In the item “date of change”, information indicating the date when the appliance information was updated is stored. In the item “user who made change”, information indicating a user who made change is stored. In the item “changed item”, information indicating the item that has been changed is stored. In the item “before change”, information before change is stored. In the item “after change”, information after change is stored.

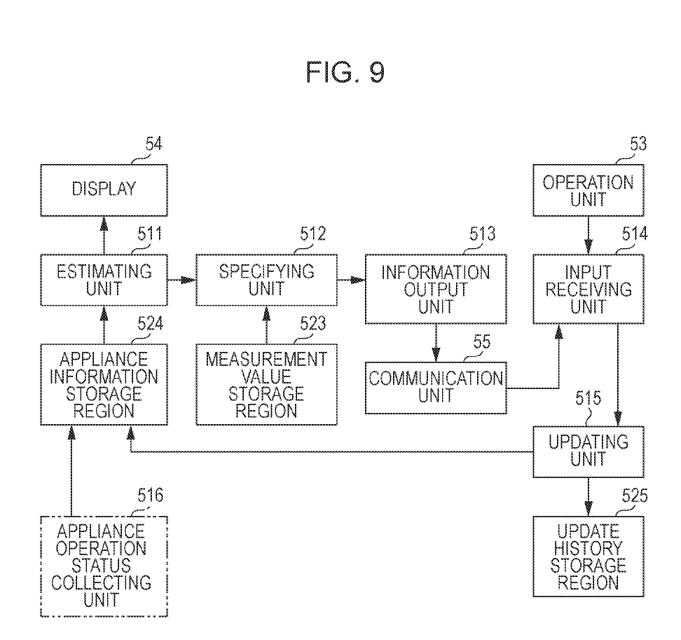

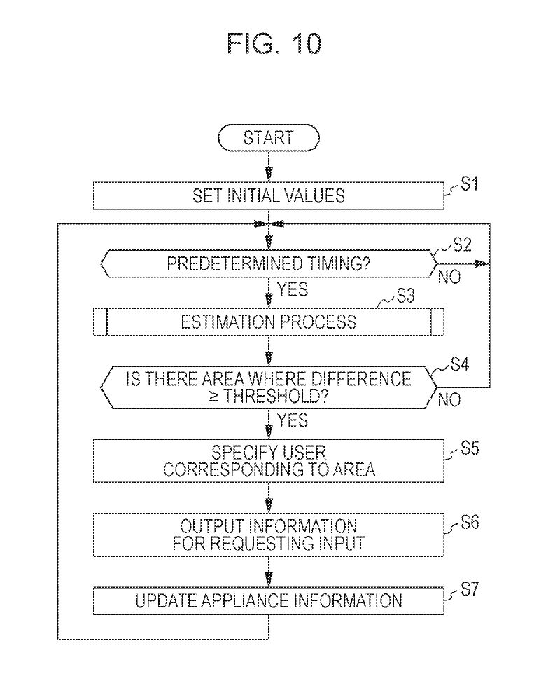

Next, a functional configuration of the managing apparatus 5 will be described with reference to FIG. 9. FIG. 9 is a diagram illustrating an example of the functional configuration of the managing apparatus 5. In FIG. 9, an estimating unit 511, a specifying unit 512, an information output unit 513, an input receiving unit 514, and an updating unit 515 are realized when the controller 51 executes a computer program stored in the ROM or the memory 52. The arrows in FIG. 9 schematically indicate the flow of data.

In FIG. 9, the estimating unit 511 estimates, in accordance with a predetermined algorithm, a power usage amount in each of the plural areas 101 by using the appliance information stored in the appliance information storage region 524. The estimating unit 511 is an example of an estimating unit according to an exemplary embodiment of the present invention. Specifically, for example, the estimating unit 511 estimates a power usage amount P in each area 101 by calculating the following expression (1), in which xi represents the number of appliances i installed in the area 101, qi represents power consumption per hour of the appliances i, ti represents an operating time per day, and pi represents the probability of operation on holidays.

$$P = {\sum }_{i} xi \cdot qi \cdot ti ( 5 + 2 pi ) \qquad ( 1 )$$

The method for estimating a power usage amount in the area 101 by using appliance information is not limited to thereto, and calculation may be performed by using another algorithm. Furthermore, any method may be used as long as the power usage amount in the area 101 is estimated in accordance with a predetermined algorithm using appliance information. Also, the estimating unit 511 may output information representing an estimation result to the display 54, thereby causing the display 54 to display the estimation result.

The specifying unit 512 compares a power usage amount measured by the measuring apparatus 4 (i.e., an amount of power stored in the measurement value storage region 523, hereinafter referred to as a “measured power usage amount”) with a power usage amount estimated by the estimating unit 511 (hereinafter referred to as an “estimated power usage amount”) in each area 101, and specifies the area 101 in which the difference therebetween satisfies a predetermined condition. The specifying unit 512 is an example of a specifying unit according to an exemplary embodiment of the present invention. More specifically, the specifying unit 512 may specify the area 101 in which a difference between a measured power usage amount and an estimated power usage amount is equal to or larger than a predetermined threshold. Furthermore, the specifying unit 512 specifies a user corresponding to the specified area 101 with reference to the content stored in the appliance information storage region 524. Specifically, for example, in a case where the content illustrated in FIG. 7 is stored in the appliance information storage region 524 and where the area 101 indicated by “point A” is specified, the specifying unit 512 specifies the users represented by “employee A”, “employee B”, and “employee X” stored in association with “point A”.

The information output unit 513 outputs information for prompting the user specified by the specifying unit 512 to input appliance information. The information output unit 513 is an example of an information output unit according to an exemplary embodiment of the present invention. More specifically, in this exemplary embodiment, the information output unit 513 reads out the e-mail address of the user specified by the specifying unit 512 from the employee information storage region 522, and transmits an e-mail for prompting the user to input appliance information to the read out e-mail address, thereby outputting the foregoing information.

The input receiving unit 514 receives input of the appliance information from the user. The input receiving unit 514 is an example of an input receiving unit according to an exemplary embodiment of the present invention. The input receiving unit 514 may receive appliance information from another apparatus via the communication network 6 and the communication unit 55, for example. Alternatively, the input receiving unit 514 may receive input of appliance information that is input by the user operating the operation unit 53, for example.

The updating unit 515 updates the appliance information stored in the appliance information storage region 524, by using the appliance information received by the input receiving unit 514. The updating unit 515 is an example of an updating unit according to an exemplary embodiment of the present invention. Specifically, for example, if an appliance 2 is newly added by “employee A”, the updating unit 515 adds the input appliance information to the appliance information storage region 524, and also stores, in the update history storage region 525, information indicating that the appliance information has been added. Also, for example, if the number of appliances 2 is changed by “employee A”, the updating unit 515 changes the value in the item “number” in the appliance information storage region 524, and stores, in the update history storage region 525, information indicating that the number of appliances 2 has been changed.

### B: Operation

Next, the operation performed by the controller 51 of the managing apparatus 5 will be described. In this exemplary embodiment, the managing apparatus 5 checks whether or not there is inconsistency of data at predetermined timings registered in the apparatus, for example, once a month or once a week. In step S1, the controller 51 of the managing apparatus 5 sets initial values of appliance information stored in the appliance information storage region 524. The initial values of appliance information may be input by a user of the managing apparatus 5 by operating the operation unit 53. Alternatively, for example, the initial values may be input by inputting a file in which the initial values of appliance information are listed. The manner of input is not limited as long as the initial values of appliance information are input.

Subsequently, the controller 51 waits until a predetermined timing (for example, a timing of once a month or once a week) comes (NO in step S2). When the predetermined timing comes (YES in step S2), the controller 51 performs a process of estimating a power usage amount (simulation process) in each area 101 in step S3.

Subsequently, the controller 51 compares a measured power usage amount stored in the measurement value storage region 523 and an estimated power usage amount in each area 101. If the difference therebetween is smaller than a predetermined threshold in all the areas 101, for example, if the difference is less than 5% (NO in step S4), the process returns to step S2 without steps S5 to S7 not being performed, and the controller 51 waits until the predetermined timing comes (NO in step S2). On the other hand, if there is an area 101 where the difference between a measured power usage amount and an estimated power usage amount is equal to or larger than the predetermined threshold (YES in step S4), the controller 51 specifies a user corresponding to the area 101 with reference to the content stored in the appliance information storage region 524 in step S5, and outputs information for requesting the specified user to input appliance information in step S6. This step may be performed by, for example, transmitting an e-mail to the e-mail address of the specified user.

After step S6, the controller 51 waits until appliance information is input by the user. The user may input the appliance information by operating the operation unit 53, or may input the appliance information to the managing apparatus 5 by causing another apparatus to transmit the appliance information. Upon the appliance information being input by the user, the controller 51 updates the content stored in the appliance information storage region 524 by using the input appliance information in step S7. Also, the controller 51 registers the updated content in the update history storage region 525.

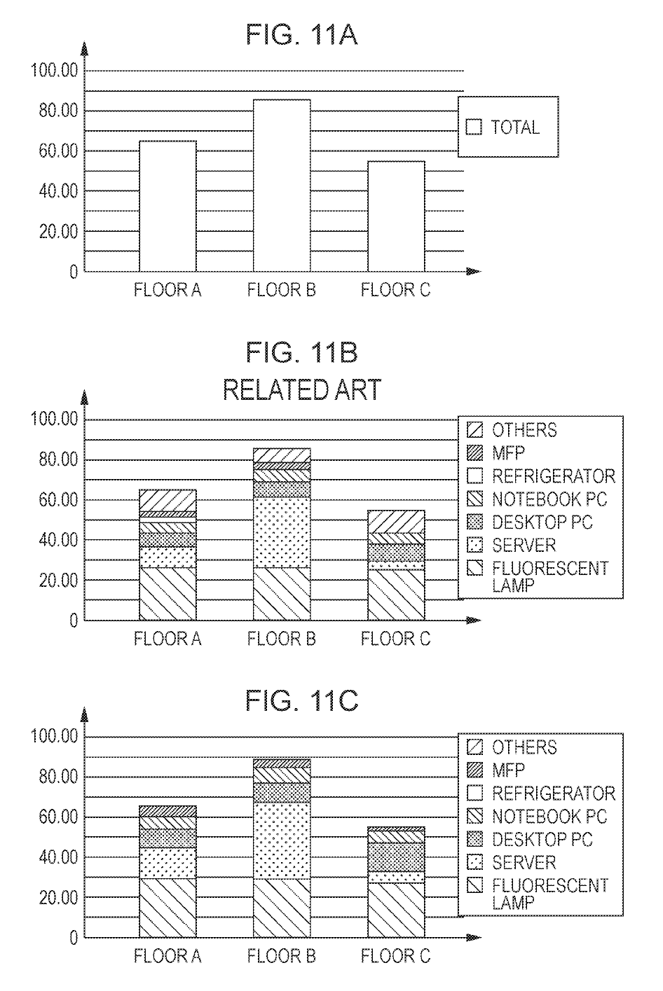

FIG. 11A is a diagram illustrating measurement results in the individual areas 101 generated by the measuring apparatuses 4. FIG. 11B is a diagram illustrating a simulation result of power usage amounts in a system according to the related art. FIG. 11C is a diagram illustrating a simulation result of power usage amounts in this exemplary embodiment. In FIG. 11A, power usage amounts in the individual areas 101 are measured. However, power usage amounts of the individual appliances 2 installed in each area 101 are unknown. In the system according to the related art illustrated in FIG. 11B, a power usage amount is estimated for each appliance 2. However, if the estimation accuracy is insufficient, the proportion of the power usage amount for “others”, indicating that the appliance used is unknown, may be high as illustrated in FIG. 11B. In contrast, according to this exemplary embodiment, a user corresponding to the area 101 where the difference between an estimated power usage amount and a measured power usage amount satisfies a predetermined condition is prompted to input information. Accordingly, the estimated value of the power usage amount in the area 101 having a large difference is corrected, and thus an estimation result closer to a measurement value may be obtained. Furthermore, in this exemplary embodiment, a user corresponding to the area 101 where the difference is large, not all the users in the space 100, is prompted to input information. Accordingly, operation loads of input performed by users may be reduced.

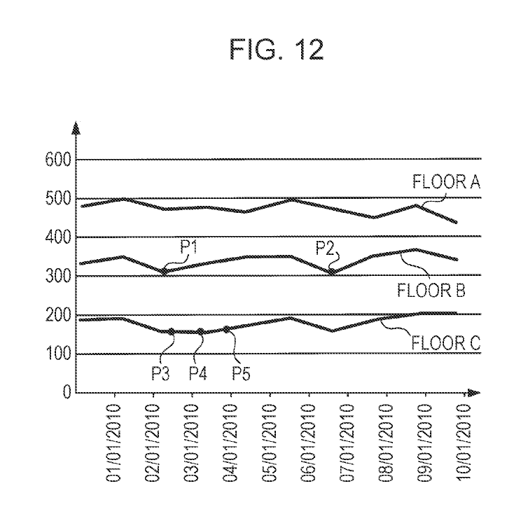

The controller 51 causes the display 54 to display an image representing an update history in accordance with the content stored in the update history storage region 525, in response to an operation performed by a user. FIG. 12 is a diagram illustrating an example of a screen presenting an update history. In the example illustrated in FIG. 12, a graph representing time-series changes in estimation results in the individual areas 101 is displayed. At this time, timings P1, P2, etc. at which the appliance information is updated are displayed, as illustrated in FIG. 12. Accordingly, the relationship between update of the appliance information and change in estimated value may be easily recognized.

### C: Modifications

The exemplary embodiment of the present invention has been described above. The present invention is not limited to the above-described embodiment, and may be carried out in other various modes. Hereinafter, examples thereof will be described. The following modifications may be appropriately combined together.

(1) In the system according to the above-described exemplary embodiment, a power usage amount is measured and estimated as an energy usage amount. The energy usage amount is not limited to a power usage amount. For example, a gas usage amount, a cold water usage amount, or the like may be used as an energy usage amount.

(2) In the above-described exemplary embodiment, the controller 51 of the managing apparatus 5 may collect operation statuses of the appliances 2 via a communication medium, and may estimate an energy usage amount by using the collection result. That is, the managing apparatus 5 may be provided with an appliance operation status collecting unit 516 (illustrated in FIG. 9 with a chained line) that collects operation statuses of the appliances 2 via a communication medium. More specifically, for example, Internet protocol (IP) addresses and media access control (MAC) addresses may be registered in the appliance information storage region 524 of the managing apparatus 5, and the appliance operation status collecting unit 516 may transmit a packet Internet groper (PING) command or an address resolution protocol (ARP) command using the registered IP addresses and MAC addresses to the appliances 2, thereby determining whether or not the appliances 2 are operating. In this case, the controller 51 estimates an operating time by summarizing determination results, and estimates an energy usage amount by using the estimated operating time. In this case, the operating time and probability of operation on holidays of the appliances 2 are accurately updated in sequence. Thus, it is not necessary for users to input an operating time and probability of operation on holidays. Accordingly, operation loads of input performed by the users may be reduced.

The controller 51 may obtain the product type of an appliance 2 via a communication medium, and may specify the power consumption corresponding to the obtained product type with reference to a table stored in advance. In this case, it is not necessary for a user to input the power consumption of the appliance 2, and the operation load of the user may be reduced.

(3) In the above-described exemplary embodiment, the controller 51 may output information for prompting a user corresponding to the appliance 2 that uses a large amount of energy to input appliance information, among users corresponding to the area 101 where the difference between a measured energy usage amount and an estimated energy usage amount satisfies a predetermined condition (hereinafter referred to as a “specific area”). In this case, the controller 51 may specify a user corresponding to the appliance 2 in which an estimated energy usage amount satisfies a predetermined condition (for example, an estimated energy usage amount is equal to or larger than a predetermined threshold) among the appliances 2 installed in the specific area 101, with reference to the content stored in the appliance information storage region 524. Accordingly, users who are to be prompted to input appliance information are narrowed down, and operation loads of input performed by users may be reduced.

(4) In the above-described exemplary embodiment, the controller 51 may output information for prompting a user corresponding to the appliance 2 that is not connected to the communication network 6 to input appliance information, among the users corresponding to the specific area 101 where the difference between a measured energy usage amount and an estimated energy usage amount satisfies a predetermined condition. In this case, the controller 51 may determine whether or not the individual appliances 2 are connected to the communication network 6 by obtaining, from the appliances 2 via a communication medium, operation status information representing the operation statuses of the appliances 2 by using various commands, such as a PING command, and may specify a user corresponding to the appliance 2 that is not connected to the communication network 6 (that is, the appliance 2 whose operation status information has not been obtained) among the appliances 2 installed in the specific area 101, with reference to the content stored in the appliance information storage region 524.

(5) In the above-described exemplary embodiment, the controller 51 may output information for prompting a user corresponding to the appliance 2 in which an update history of appliance information satisfies a predetermined condition (for example, an update frequency is equal to or higher than a threshold, an update frequency is lower than a threshold, or an amount of change in the value of updated appliance information is equal to or larger than a threshold), among the users corresponding to the specific area 101 where the difference between a measured energy usage amount and an estimated energy usage amount satisfies a predetermined condition, to input appliance information.

(6) In the above-described exemplary embodiment, the controller 51 performs a process of estimating an energy usage amount and a process of comparing a measured energy usage amount and an estimated energy usage amount at a predetermined timing (for example, once a month or once a week). The timing to perform an estimation process and a comparison process is not limited thereto. For example, the controller 51 may perform an estimation process once a day, and may perform a comparison process once a month. Alternatively, the controller 51 may perform an estimation process once a week, and may perform a comparison process in response to an instruction to perform a comparison process provided from a user.

(7) In the above-described exemplary embodiment, the number, power consumption per appliance (W), operating time per day, and probability of operation on holidays of the appliances 2 in each area 101 are used as appliance information. The appliance information is not limited thereto, and other information may be used. That is, any information about an energy usage status in the appliances 2 and any information used by the controller 51 to perform a process of estimating an energy usage amount may be used as appliance information.

(8) In the above-described exemplary embodiment, the controller 51 outputs information for prompting a user to input appliance information by transmitting an e-mail to the user. However, the method for outputting information for prompting a user to input appliance information is not limited thereto. For example, the controller 51 may prompt a user to input appliance information by outputting a voice message or alarm sound. Alternatively, the controller 51 may output, to a light source such as a light-emitting diode (LED), a control signal for turning on the light source, and may prompt a user to input appliance information by turning on the light source. That is, any method may be used as long as the controller 51 outputs information for prompting a user to input appliance information.

(9) In the above-described exemplary embodiment, the managing apparatus 5 and the measuring apparatus 4 are separated from each other. Alternatively, a single apparatus having the function of the managing apparatus 5 and the function of the measuring apparatus 4 may be used.

In the above-described exemplary embodiment, the managing apparatus 5 as a single body is used. Alternatively, two or more apparatuses connected to each other via a communication medium may share the function of the managing apparatus 5 according to the above-described exemplary embodiment, and a system including these apparatuses may realize the managing apparatus 5 according to the exemplary embodiment. For example, a computer apparatus having a function of estimating an energy usage amount and a computer apparatus that outputs information for prompting a user to input appliance information in accordance with a difference between an estimated energy usage amount and a measured energy usage amount may be connected to each other via a communication medium so as to constitute a system.

(10) A program executed by the controller 51 of the managing apparatus 5 in the above-described exemplary embodiment may be provided while being stored in a computer readable recording medium, such as a magnetic recording medium including a magnetic tape and a magnetic disk, an optical recording medium including an optical disc, a magneto-optical recording medium, or a semiconductor memory. This program may be downloaded via a communication network, such as the Internet. Various devices other than a CPU may be used as a controller for performing such control, for example, a dedicated processor may be used.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An energy usage amount managing apparatus comprising:
a memory that stores appliance information about an energy usage status in each of appliances installed in a space having a plurality of areas, and that stores information about the plurality of areas and information about users in association with each other;
an estimating unit that estimates, in accordance with a predetermined algorithm, an energy usage amount in each of the plurality of areas by using the appliance information stored in the memory;
a specifying unit that specifies, with reference to content stored in the memory, a user corresponding to an area where a difference between an energy usage amount measured by a measuring apparatus and an energy usage amount estimated by the estimating unit satisfies a predetermined condition among the plurality of areas, the measuring apparatus being provided in each of the plurality of areas and measuring an energy usage amount in a corresponding one of the plurality of areas;
an information output unit that outputs information for prompting the user specified by the specifying unit to input the appliance information about an appliance installed in the area where the difference between the measured energy usage amount and the estimated energy usage amount satisfies the predetermined condition among the appliances;
an input receiving unit that receives input of the appliance information; and
an updating unit that updates the content stored in the memory by using the appliance information received by the input receiving unit.

2. The energy usage amount managing apparatus according to claim 1,
wherein the memory stores information about the appliances and information about the users in association with each other,
wherein the estimating unit estimates, in accordance with a predetermined algorithm, an energy usage amount of each of the appliances in each of the plurality of areas by using the appliance information stored in the memory, and
wherein the specifying unit specifies, with reference to the content stored in the memory, a user corresponding to an appliance in which an energy usage amount estimated by the estimating unit satisfies a predetermined condition among the appliances installed in the area where the difference between the energy usage amount estimated by the estimating unit and the energy usage amount measured by the measuring apparatus satisfies the predetermined condition among the plurality of areas.

3. The energy usage amount managing apparatus according to claim 1,
wherein the input receiving unit receives input of the appliance information for adding the appliance, and
wherein the updating unit updates the content stored in the memory so that the appliance corresponding to the appliance information received by the input receiving unit is added to the area where the difference between the measured energy usage amount and the estimated energy usage amount satisfies the predetermined condition.

4. The energy usage amount managing apparatus according to claim 1, further comprising:
an obtaining unit that obtains, from the appliances via a communication medium, operation status information representing an operation status of each of the appliances,
wherein the estimating unit estimates the energy usage amount by using the appliance information stored in the memory and the operation status information obtained by the obtaining unit, and
wherein the specifying unit specifies, with reference to the content stored in the memory, a user corresponding to an appliance for which the operation status information has not been obtained by the obtaining unit among the appliances installed in the area where the difference between the energy usage amount estimated by the estimating unit and the energy usage amount measured by the measuring apparatus satisfies the predetermined condition.

5. The energy usage amount managing apparatus according to claim 1, further comprising:
an update history memory that stores, for each of the appliances, an update history generated by the updating unit,
wherein the specifying unit specifies a user corresponding to an appliance in which the update history stored in the update history memory satisfies a predetermined condition among the appliances.

6. An energy usage amount management method comprising:
storing appliance information about an energy usage status in each of appliances installed in a space having a plurality of areas, and storing information about the plurality of areas and information about users in association with each other;
estimating, in accordance with a predetermined algorithm, an energy usage amount in each of the plurality of areas by using the appliance information stored in the storing;
specifying, with reference to content stored in the storing, a user corresponding to an area where a difference between an energy usage amount measured by a measuring apparatus and an energy usage amount estimated in the estimating satisfies a predetermined condition among the plurality of areas, the measuring apparatus being provided in each of the plurality of areas and measuring an energy usage amount in a corresponding one of the plurality of areas;
outputting information for prompting the specified user to input the appliance information about an appliance installed in the area where the difference between the measured energy usage amount and the estimated energy usage amount satisfies the predetermined condition among the appliances;
receiving input of the appliance information; and
updating the content stored in the storing by using the received appliance information.

7. A computer readable medium storing a program causing a computer to execute a process, the process comprising:
storing appliance information about an energy usage status in each of appliances installed in a space having a plurality of areas, and storing information about the plurality of areas and information about users in association with each other;
estimating, in accordance with a predetermined algorithm, an energy usage amount in each of the plurality of areas by using the appliance information stored in the storing;
specifying, with reference to content stored in the storing, a user corresponding to an area where a difference between an energy usage amount measured by a measuring apparatus and an energy usage amount estimated in the estimating satisfies a predetermined condition among the plurality of areas, the measuring apparatus being provided in each of the plurality of areas and measuring an energy usage amount in a corresponding one of the plurality of areas;
outputting information for prompting the specified user to input the appliance information about an appliance installed in the area where the difference between the measured energy usage amount and the estimated energy usage amount satisfies the predetermined condition among the appliances;
receiving input of the appliance information; and
updating the content stored in the storing by using the received appliance information.
